(19) United States
(12) Patent Application Publication
(10) Pub. No.: US 2016/0377125 A1
(43) Pub. Date: Dec. 29, 2016

(54) ASSEMBLY FOR A SYNCHRONIZATION UNIT OF A GEAR-CHANGING TRANSMISSION

(71) Applicant: OERLIKON FRICTION SYSTEMS (GERMANY) GMBH, Bremen (DE)

(72) Inventors: Ulf CHRISTOFFER, Bremen (DE); Ralf FREDE, Freissenbuettel (DE); Marcus SPRECKELS, Sagehorn (DE)

(73) Assignee: OERLIKON FRICTION SYSTEMS (GERMANY) GMBH, Bremen (DE)

(21) Appl. No.: 15/184,509

(22) Filed: Jun. 16, 2016

(30) Foreign Application Priority Data
Jun. 26, 2015 (EP) 15174118.8

(51) Int. Cl. F16D 23/02; F16D 13/66

(52) U.S. Cl. CPC F16D 23/025; F16D 13/66; F16D 2200/0026; F16D 2200/0052; F16D 2250/0046; F16D 2250/0053; F16D 2300/10

(57) ABSTRACT

Assembly for synchronization unit of gear-changing transmission includes a friction ring and synchronizer ring. Friction ring has a conical friction ring body with friction surface and an installation surface that respectively bound friction ring body in a radial peripheral direction extending perpendicular to an axial friction ring axis. Friction surface extends at a predefinable friction angle and installation surface extends at a predefinable installation angle, in each case conically. Synchronizer ring has a contact surface corresponding to installation surface of friction ring. Synchronizer ring and friction ring are adapted so that contact surface of synchronizer ring contacts installation surface of friction ring, and friction surface of friction ring is in rubbing contact with a gear wheel during a synchronization process where synchronizer ring is displaced in a direction of a gear wheel to be synchronized. Installation surface of friction ring and/or contact surface of synchronizer ring has/have adhesion-reducing surface structure.

### CROSS-REFERENCE TO RELATED APPLICATIONS

The present application claims priority under 35 U.S.C. §119(a) of European Patent Application No. EP 151 74 118.8 filed Jun. 26, 2015, the disclosure of which is expressly incorporated by reference herein in its entirety.

### BACKGROUND OF THE INVENTION

1. Field of the Invention

The invention relates to an assembly for a synchronization unit of a gear-changing transmission in accordance with the preamble of claim 1 as well as to a friction ring and to a synchronizer ring for such an assembly and to a synchronization unit and to a gear-changing transmission having such an assembly.

2. Discussion of Background Information

An assembly for a synchronization unit of a gear-changing transmission of a vehicle is described in EP 2 677 187 A1. The assembly has a friction ring which comprises a conical friction ring body having an inner friction surface and an outer installation surface which respectively bound the friction ring body in a radial peripheral direction extending perpendicular to an axial friction axis. The inner friction surface in this respect extends at a predefinable friction angle and the outer installation surface extends at a predefinable installation angle, in each case conically along the friction ring axis. The assembly additionally has a synchronizer ring having a contact surface corresponding to the outer installation surface of the friction ring. The synchronizer ring and the friction ring are configured and arranged such that the contact surface of the synchronizer ring contacts the outer installation surface of the friction ring and the inner friction surface of the friction ring is in rubbing contact with a gear wheel during a synchronization process in which the synchronizer ring is displaced in the direction of the gear wheel to be synchronized.

The use of such an assembly in a synchronization unit of a gear-changing transmission on the one hand allows a high efficiency, that is a large reinforcement effect between the actuation force and the synchronization torque, and simultaneously a high shifting comfort. This is achieved by the spatial separation of the function “generate synchronizing torque” and “release friction pairing” which are combined in one and the frame friction pairing in synchronization units which are based on the so-called Borg-Warner concept. The separation is achieved by the use of an assembly composed of a friction ring having a friction surface and an installation surface and of a synchronizer ring having a contact surface corresponding to the installation surface of the friction ring instead of only one synchronizer ring having one or more friction surfaces. The friction surface of the friction ring produces the synchronizing torque in a force-transmitting manner; a reliable releasing of the force fit takes place at the contact surface and at the installation surface. An independent optimization of the two functions can thus take place with respect to their specific demands.

On the use of the described synchronization unit disturbances in comfort and function may in particular occur at low operating temperatures in the form of a so-called second pressure point or blocked gearshifts may also occur.

### SUMMARY OF THE EMBODIMENTS

In light of foregoing, embodiments of the invention provide an assembly for a synchronization unit of a gear-changing transmission which allows an operationally secure and comfortable operation of the gear-changing transmission.

The assembly in accordance with the invention for a synchronization unit of a gear-changing transmission has a friction ring which comprises a conical friction ring body having a friction surface, in particular an inner friction surface, and having an installation surface, in particular an outer installation surface, which respectively bound the friction ring body in a radial peripheral direction extending perpendicular to an axial friction ring axis. The friction surface in this respect extends at a predefinable friction angle and the outer installation surface extends at a predefinable installation angle, in each case conically along the friction ring axis. The assembly additionally has a synchronizer ring having a contact surface corresponding to the installation surface of the friction ring. The synchronizer ring and the friction ring are configured and arranged such that the contact surface of the synchronizer ring contacts the installation surface of the friction ring and the friction surface of the friction ring is in rubbing contact with a gear wheel during a synchronization process in which the synchronizer ring is displaced in the direction of the gear wheel to be synchronized. A speed of revolution matching can take place between the gear wheel and the friction ring and thus also with the synchronizer ring which is in particular rotationally fixedly connected to the friction ring. The friction ring and/or the synchronizer ring has/have so-called securities against rotation for the rotationally fixed coupling between the friction ring and the synchronizer ring.

In accordance with the invention, the installation surface of the friction ring and/or the contact surface of the synchronizer ring of the assembly has/have an adhesion-reducing surface structure.

The adhesion between the installation surface of the friction ring and the contact surface of the synchronizer ring is thus minimized. This prevents a sticking together of the friction ring and the synchronizer ring, which can have the result on the releasing of the friction pairing that the above-described spatial separation of the functions is no longer present and the release of the friction pairing takes place at the friction surface of the friction ring not provided and configured for this purpose. If the friction ring and the synchronizer ring cannot be released from one another, they act as a synchronizer ring of a Borg-Warner synchronization on the release of the friction pairing. The described problem of the sticking together in this respect in particular occurs at low operating temperatures and the high viscosity associated therewith of the transmission oil serving for the lubrication and the cooling.

A corresponding contact surface of the synchronizer ring should be understood in this connection such that the contact surface and the installation surface are designed such that they come into contract with a sufficient displacement of the synchronizer ring in the direction of the friction ring axis toward the friction ring. They thus have substantially the same angle with respect to the friction ring axis.

The friction ring is in particular designed as a slit or open ring, that is as a ring having an interruption. It can also be designed as a segmented ring, that is, as a ring which comprises a plurality of individual ring segments, for example two to eight.

The friction angle of the friction ring in particular differs from the installation angle of the friction ring. The installation angle of the friction ring is specifically larger than the friction angle of the friction ring. This allows a particularly high efficiency and at the same time a particularly high shifting comfort.

In an embodiment of the invention, the installation surface of the friction ring and/or the contact surface of the synchronizer ring has/have recesses. The size of the surface on which the friction ring and the synchronizer ring are in contact is thus reduced with respect to an embodiment without the named recesses. Since the adhesion between the friction ring and the synchronizer ring depends very substantially on the size of this surface, that is likewise increases as the size of the surface increases, this results in a particularly low adhesion and thus, as described, in a high shifting comfort.

The recesses can have a depth between some micrometers and some millimeters. They can, for example, have a proportion in the total surfaces between 20 and 80%. The recesses can, for example, be introduced in the contact surfaces via a shaping tool for manufacturing the friction ring or the synchronizer ring or can be produced in a separate machining step by a material-removing machining such as turning, grinding, pounding, laser machining or milling or via a shaping machining such as rolling or stamping.

The recesses are designed as grooves and/or holes in an embodiment of the invention. The grooves can, for example, extend substantially along the friction ring axis or in the peripheral direction. They can, however, also extend at an inclination with respect to the peripheral direction. The holes can be designed as passage holes or as blind holes and can in particular have a circular diameter which can also be deformed in subsequent forming steps, for example to form an ellipse. The holes can have identical or also different diameters, for example between 1 and 5 mm. Such grooves, holes or bores can be manufactured very simply and thus inexpensively.

In an embodiment of the invention, the recesses are produced by a shot blasting process or sandblasting process. An uneven surface structure can thus be achieved, which allows a particularly high surface share of recesses and thus a particularly low adhesion. In addition, this makes possible a simple and thus inexpensive manufacture of the synchronizer ring and of the friction ring.

In an embodiment of the invention, the recesses are formed as a laser texturizing. A desired, ideal surface structure can thus be produced.

In an embodiment of the invention, the recesses are produced by an etching process. This allows a particularly inexpensive manufacture of a desired surface structure.

In an embodiment of the invention, the installation surface of the friction ring and/or the contact surface of the synchronizer ring has/have an adhesion-reducing coating. The adhesion properties of the surfaces can thus be influenced particularly well. The coating can, for example, have a thickness of some nanometers in so-called thin-film coatings up to several micrometers, for example by thermal spraying. The named surfaces can have only a coating or can have the coating in addition to the above-named recesses.

In an embodiment of the invention, the adhesion-reducing coating is formed as a carbon layer, in particular as an amorphous carbon layer. Such coatings are also called diamond-like carbon (DLC) layers. Desired surface properties, that is, also adhesion properties, can thus be achieved very effectively.

In an embodiment of the invention, the friction ring and the synchronizer ring consist of different materials, in particular the friction ring consists of sheet metal and the synchronizer ring consists of brass. The adhesion between the friction ring and the synchronizer ring also depends on the material they comprise. There are material pairs such as sheet metal and brass which have a small adhesion inclination. It is even possible that the selection of a suitable material pair is sufficient to satisfy the above-named object of the invention. An assembly which satisfies the above-named object can thus have a friction ring and a synchronizer ring from different materials without the installation surface of the friction ring and/or the contact surface of the synchronizer ring having an adhesion-reducing surface structure.

The invention further relates to a friction ring for an assembly in accordance with the invention, to a synchronizer ring for an assembly in accordance with the invention, to a synchronization unit for a gear-changing transmission having an assembly in accordance with the invention and a gear-changing transmission for a vehicle having an assembly in accordance with the invention.

Other exemplary embodiments and advantages of the present invention may be ascertained by reviewing the present disclosure and the accompanying drawing.

### BRIEF DESCRIPTION OF THE DRAWINGS

Further advantages, features and details of the invention result with reference to the following description of embodiments and with reference to drawings in which elements which are the same or have the same function are provided with identical reference numerals.

There are shown:

FIG. 1a a friction ring having segmented friction ring bodies in an expanded configuration;

FIG. 1b the friction ring in accordance with FIG. 1a in a compressed configuration;

FIG. 1c a section along the line I-I in accordance with FIG. 1a;

FIG. 1d a section of the friction ring in accordance with FIG. 1a or FIG. 1b in a perspective view;

FIG. 2a a second embodiment of a segmented friction ring having radial securities against rotation;

FIG. 2b a section of the friction ring in accordance with FIG. 2a in a perspective view;

FIG. 3 an embodiment of a synchronization unit with an assembly of friction ring and synchronizer ring;

FIG. 4a a slit friction ring in an expanded configuration;

FIG. 4b the slit friction ring in accordance with FIG. 4a in a compressed configuration;

FIG. 5 a section through an assembly of friction ring and synchronizer ring in a synchronization unit;

FIG. 6 a very schematic representation of a gear-changing transmission;

FIG. 7 a section through a friction ring with a coated outer installation surface; and

FIG. 8 a section through a friction ring with a coated contact surface; and

FIGS. 9a-9h sections of contact surfaces of synchronizer rings and outer installation surfaces of friction rings with different surface structures.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

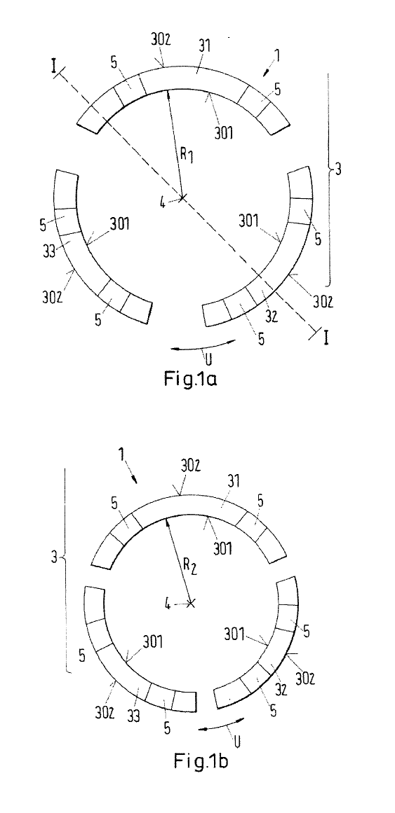

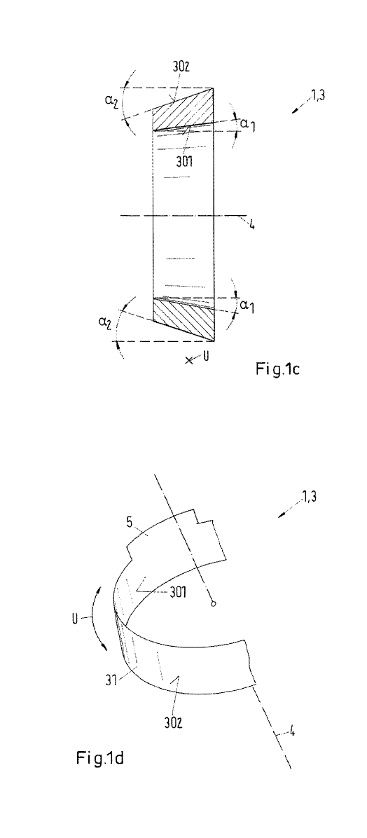

FIG. 1a and FIG. 1b or FIG. 1c and FIG. 1d show one and the same very simple embodiment of a friction ring having a segmented friction body in a schematic representation, wherein the friction ring is designated as a whole in the following by the reference numeral 1.

The same reference numerals designate the same features in all Figures.

FIG. 1a shows the friction ring 1 in this respect in an expanded configuration, whereas FIG. 1b shows the same friction ring in a compressed configuration. FIG. 1 shows for better understanding a section along the line I-I in accordance with FIG. 1a, whereas a section of the friction ring 1 in accordance with FIG. 1a and FIG. 1b is shown in a perspective view with reference to FIG. 1d to be able to better see the securities against rotation 5 extending along the friction ring axis 4 of the friction ring 1. The securities against rotation 5 serve for the rotationally fixed coupling of the friction ring I with a synchronizer ring not shown in FIGS. 1a-1d.

The friction ring 1 in accordance with FIG. 1a to FIG. 1d serves for the use in a synchronization unit 2 of a gear-changing transmission, in particular for a vehicle, specifically for a passenger car, for a transporter or for a truck. The friction ring 1 comprises a conical friction ring body 3 having an inner friction surface 301 and an outer installation surface 302 which respectively bound the friction ring body 3 in a radial peripheral direction U extending perpendicular to an axial friction ring axis 4. In this respect, the inner friction surface 301 extends at a predefinable friction angle α₁ and the outer installation surface 302 extends at a predefinable installation angle α₂, in each case conically along the friction ring axis 4, wherein the friction angle α₁ differs from the installation angle α₂.

As can in particular be seen from FIG. 1c, the installation angle α₂ is larger than the friction angle α₁. In this respect, it is also possible in principle that the friction angle α₁ is larger than the installation angle α₂.

As can clearly be recognized with reference to FIG. 1a and FIG. 1, the friction ring body 3 in this specific embodiment is a segmented friction ring body 3 which comprises a plurality of separate friction ring segments 31, 32, 33, in the present specific embodiment that is three friction ring segments 31, 32, 33 which form the friction ring body 3 in a ring-shaped arrangement such that the friction ring body 3 in a first expanded configuration in accordance with FIG. 1a has a first radius R₁ and in a second compressed configuration in accordance with FIG. 1b has a second radius R₂.

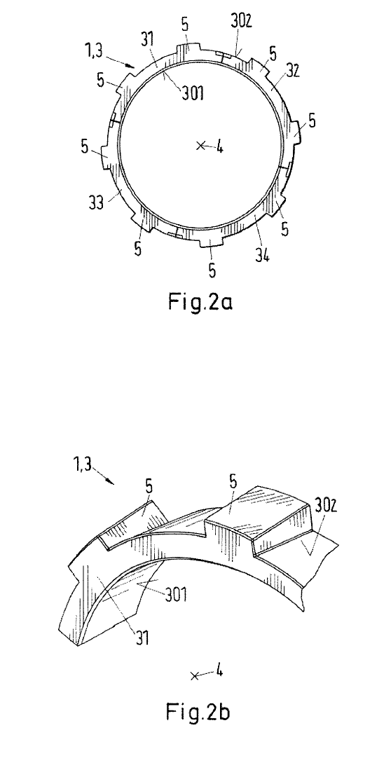

It is understood in this respect that the friction ring 1 can also be built up from a different number of friction ring segments 31, 32, 33, 34, e.g. as shown by way of example with reference to FIG. 2a and FIG. 2b, also of four friction ring segments 31, 32, 33, 34 or also, for example, only of two or more than four friction ring segments 31, 32, 33, 34.

In this respect at least one security against rotation 5 is particularly preferably provided at the friction ring body 3 and preferably extends along the friction ring axis 4, which can be seen particularly clearly from FIG. 1d.

FIG. 2a and FIG. 2b in this respect show the already mentioned other embodiment of a friction ring I in accordance with the invention in which the security against rotation 5 extends substantially perpendicular to the friction ring axis 4.

It is self-explanatory in this respect that independently of the shown specific embodiments the number of securities against rotation 5 can differ in dependence on the embodiment and any desired number of securities against rotation 5 can be provided. In very specific cases, it is even possible that the securities against rotation 5 are missing at the friction ring 1; and/or that, for example, other measures can be provided which prevent a rotation of the friction ring 1 in the operating state.

A friction coating, in particular a friction coating in the form of a carbon friction layer, which is not shown explicitly in the Figures for reasons of clarity and which can inter alia serve to at least partly compensate a resulting high mechanical and/or thermal load on the friction pairing can particularly advantageously be provided at the friction surface 301.

The friction ring 1 is in this respect particularly advantageously a stamped steel part or a shaped sheet metal part, which in particular makes industrial mass production particularly simple or inexpensive.

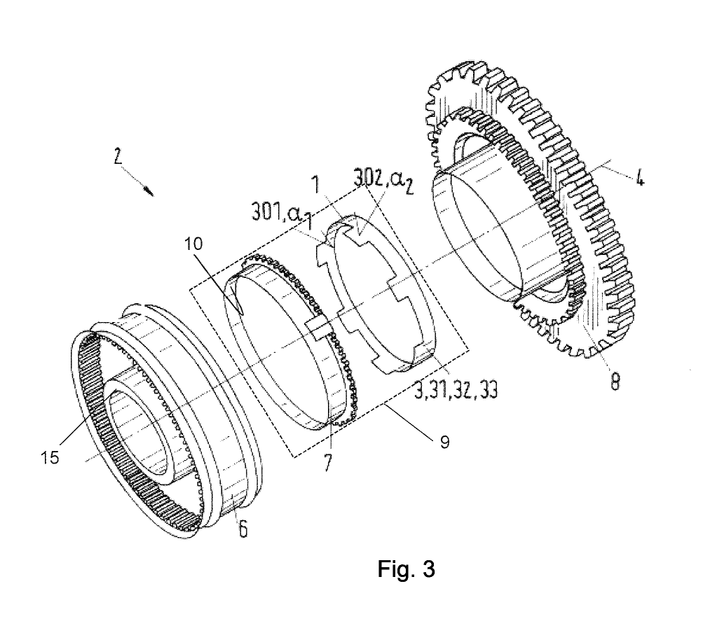

FIG. 3 shows in a schematic representation a synchronization unit 2 having a friction ring 1.

The synchronization unit 2 in accordance with FIG. 3 further comprises, in addition to the friction ring 1, in a manner known per se a sliding coupling 6 having a synchronizer body 15, a synchronizer ring 7 and a gear wheel 8, wherein the aforesaid components are arranged coaxially to the friction ring axis 4 such that the synchronizer ring 7 can be displaced in the operating state by the sliding coupling 6 together with the friction ring 1 along the friction ring axis 4 in the direction toward the gear wheel 8 so that the inner friction surface 301 of the friction ring body 3 can be brought into engagement with the gear wheel 8. The synchronizer ring 7 and the friction ring 1 in this respect Run an assembly 9 of the synchronization unit.

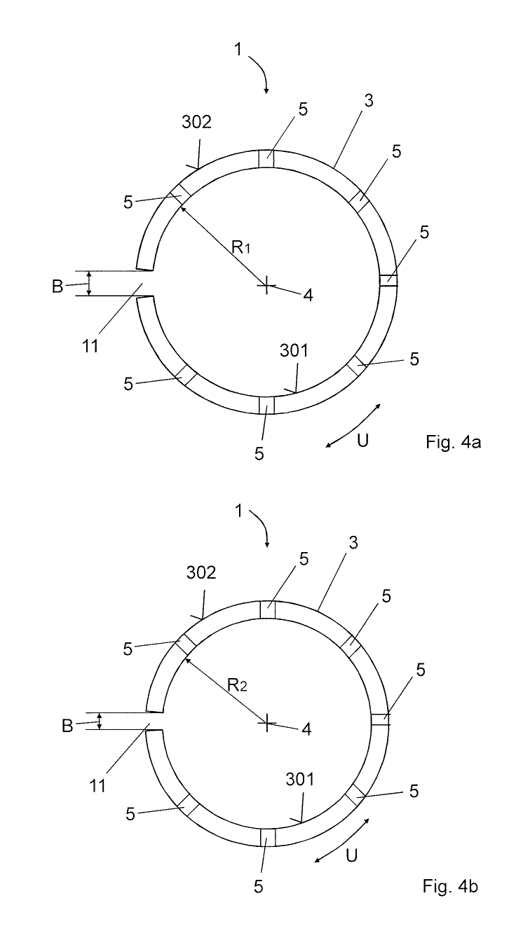

The synchronizer ring 7 is in this respect produced from brass; it can, however, also be produced from stamped steel of conventional construction. The cone of the synchronizer ring 7 which is formed by a contact surface 10 in this respect has the same large inner angle α₂, that is identical to the installation angle α₁ of the friction ring 1. The contact surface 10 of the synchronizer ring 7 thus corresponds to the outer installation surface 302 of the friction ring 1. The synchronizer ring 7 additionally has coupling pockets, known per se and not shown in any more detail, for the segmented friction ring 1. The segmented friction ring 1 in accordance with FIG. 3 is segmented into three equally large friction ring segments 31, 32, 33, which is not shown in detail for reasons of clarity in FIG. 3. The friction ring in particular consists of sheet metal. The friction ring 1 in accordance with the invention in this respect has the installation surface 302 having the installation angle α₂, with the installation surface 302 being used as a separation surface. The inner cone of the friction ring 1 is formed by the friction surface 301 having a friction angle α₁, where α₁<α₂. This inner cone surface, that is the friction surface 301, is used for synchronizing. The friction ring can also be designed as a slit ring in accordance with FIGS. 4a and 4b.

In the operating state, the synchronizer ring 7 is displaced axially in the direction toward the gear wheel 8 which is configured as a toothed wheel and thus the three friction ring segments 31, 32, 33 of the friction ring 1 are also covered by the angle α₂. The synchronizer ring 7 and the segmented friction ring 1 are then moved simultaneously together and engage with the inner cone, that is with the friction surface 301 at the friction angle α₁, onto the gear wheel 8 which likewise has a corresponding counter-cone having a cone angle α₁. The synchronizer ring 7 can then control and index like a conventional synchronizer ring. The teeth of the sliding coupling 6 are in contact with the teeth of the synchronizer ring 7 and so generate a torque between the segmented friction ring 1 and the gear wheel 8 by the different speed of revolution.

After the synchronization, when the difference revolution speed is zero, the sliding coupling 6 is moved axially, with it passing the synchronizer ring teeth and then being in contact with the teeth of the flanks of the gear wheel 8. As a result of this, there is no longer any axial force on the synchronizer ring 7. The large angle α₂ will separate the system (angle>tan⁻¹ μ). This results due to the elimination of the forces in the peripheral direction of the segmented friction ring 1. At this point, the synchronizer ring 7 and the segmented friction ring 1 break free of the gear wheel 8. The sliding coupling 6 can subsequently pass the gear wheel 8. The gearshift is then completely in engagement.

In this respect, at least two options 1 and 2 are possible. With option 1, the friction surface faces the inner cone of the segments having the small angle α₁. The large release angle α₂ is on the outer cone surface of the segments.

With option 2, the friction surface has the small angle α₁ on the outer cone of the segments. The large release angle α₂ is on the inner cone surface of the segments, with option 1 being the preferred concept in practice.

In FIG. 4a, an alternative embodiment of a friction ring 1 in accordance with the invention is shown schematically in an expanded configuration with a radius R₁ which can be used, for example, in the synchronization unit in accordance with FIG. 3.

The friction ring 1 comprises a slit friction ring body 3. Precisely one slit 11 is arranged in the friction ring body 3 and has a width B which sweeps over approximately 3 mm of the periphery of the friction ring body in the peripheral direction U.

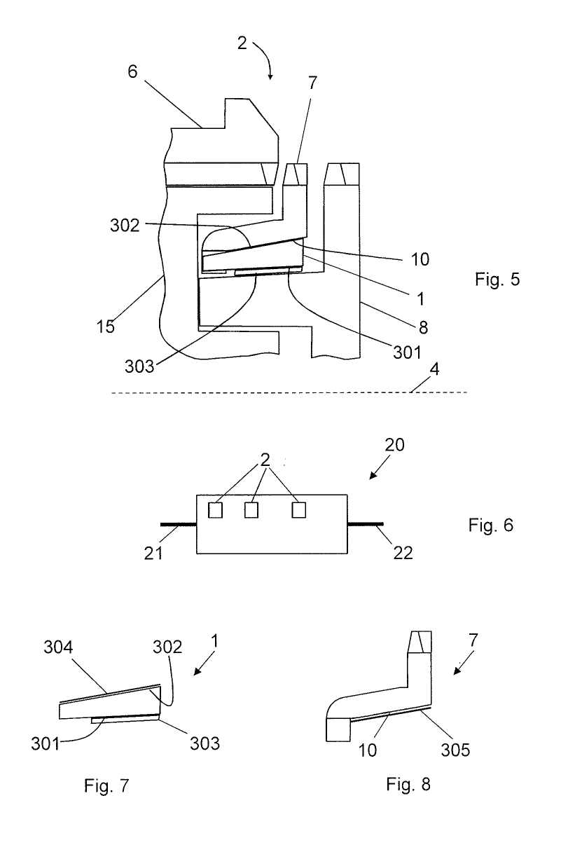

In FIG. 4b, the friction ring 1 in accordance with FIG. 4 is shown in a compressed configuration having the radius R₂. The slit 11 in accordance with FIG. 5 has a smaller width B than the slit in accordance with FIG. 4a. The friction ring can also in particular be designed such that in the compressed configuration, that is in the unloaded state, the opposite ends do not touch, that is a slit is no longer present. It is particularly advantageous if a pressing force of 4 to 5 N is present at the ends. A widening of the friction ring after a cutting open of the friction ring can be countered, for example, in that a tension is introduced at its surface, in particular at the installation surface. This can take place, for example, by nitriding or sandblasting.

In FIG. 5, a section of a synchronization unit 2 is shown schematically in an operating state., that is in a synchronizing process. The synchronization unit 2 comprises a gear wheel 8, a synchronizer ring 7, a friction ring 1, a synchronizer hub 15 and a sliding coupling 6. The synchronizer ring 7 is displaced in the direction of the gear wheel 8 to be synchronized such that the contact surface 10 of the synchronizer ring 7 contacts the installation surface 302 of the friction ring 1, whereby a rubbing contact arises between a friction layer 303 of the friction surface 301 and the gear wheel 8 and a speed of revolution matching takes place between the gear wheel 8 and the friction ring 1 and thus the synchronizer ring 7.

The contact surface 10 of the synchronizer ring 7 and/or the installation surface 302 of the friction ring 1 in this respect have an adhesion-reducing surface structure which will be looked at in connection with FIGS. 7, 8 and 9a-9h.

A gear-changing transmission 20 for a vehicle, in particular a motor vehicle, is shown very schematically in FIG. 6. The gear-changing transmission 20 has a transmission input shaft 21 and a transmission output shaft 22 and a total of three synchronization units 2 by which gear changes can be carried out in the gear-changing transmission 20.

A friction ring 1 is shown in a sectional representation in accordance with FIG. 5 in FIG. 7. The friction ring 1 has a friction layer 303 at the inner friction surface 301 and a carbon layer at the outer installation surface 302 in the form of a DLC layer 304 as an adhesion-reducing coating and thus as an adhesion-reducing surface structure.

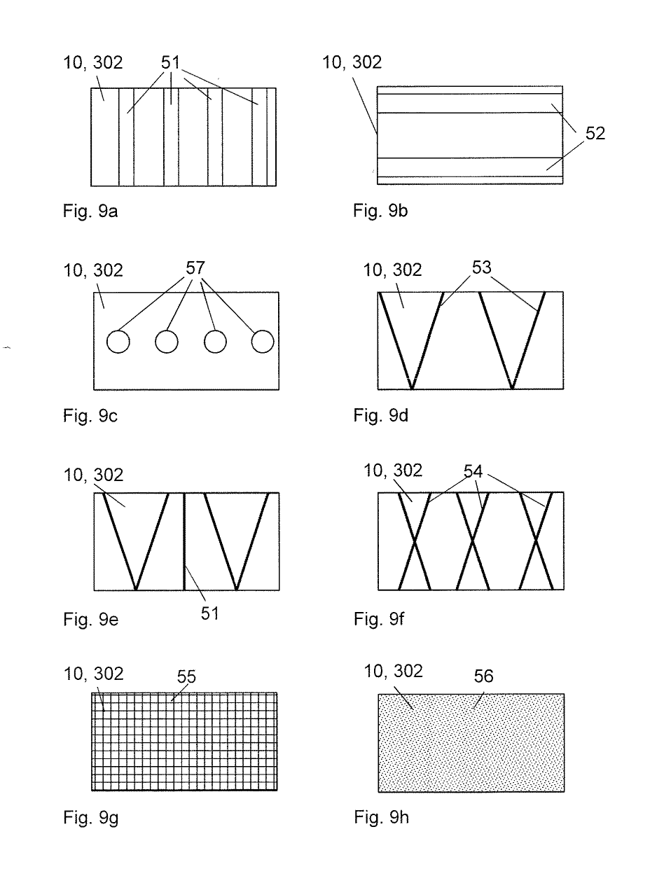

A synchronizer ring 7 is shown in a sectional representation in accordance with FIG. 5 in FIG. 8. The synchronizer ring 7 has at the contact surface 10 a carbon layer in the foam of a DLC layer 305 as an adhesion-reducing coating and thus as an adhesion-reducing surface structure.

FIGS. 9a-9h show details of contacts surfaces 10 of synchronizer rings 7 and of installation surfaces 302 of friction rings 1 having different surface structures which all have recesses.

The recesses are formed as axial grooves 51 in FIG. 9a which extend substantially along the friction ring axis 4.

The recesses are formed as radial grooves 52 in FIG. 9b which extend substantially in the peripheral direction U.

The recesses are formed as bores 57 in FIG. 9c which can be designed as blind hole bores or as passage bores.

The recesses are formed as V grooves 53 in FIG. 9d.

The recesses are formed as a combination of axial grooves 51 and V grooves 53 arranged therebetween in FIG. 9e.

The recesses are formed as X grooves 54 in FIG. 9f.

The recesses are formed as a laser texturizing 55 in FIG. 9g.

The recesses 56 have been produced by a shot blasting process, a sandblasting process or an etching process in FIG. 9h.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An assembly for a synchronization unit of a gear-changing transmission comprising:
a friction ring which comprises a conical friction ring body having a friction surface and an installation surface which respectively bound the friction ring body in a radial peripheral direction extending perpendicular to an axial friction ring axis, wherein the friction surface extends at a predefinable friction angle and the installation surface extends at a predefinable installation angle, in each case conically along the friction ring axis; and
a synchronizer ring having a contact surface corresponding to the installation surface of the friction ring;
wherein the synchronizer ring and the friction ring are configured and arranged such that the contact surface of the synchronizer ring contacts the installation surface of the friction ring and the friction surface of the friction ring is in rubbing contact with a gear wheel during a synchronization process in which the synchronizer ring is displaced in the direction of the gear wheel to be synchronized, and
wherein the installation surface of the friction ring and/or the contact surface of the synchronizer ring has/have an adhesion-reducing surface structure.

2. An assembly in accordance with claim 1, wherein the friction angle of the friction ring differs from the installation angle of the friction ring.

3. An assembly in accordance with claim 2, wherein the installation angle of the friction ring is larger than the friction angle of the friction ring.

4. An assembly in accordance with claim 1, wherein the installation surface of the friction ring and/or the contact surface of the synchronizer ring has/have recesses.

5. An assembly in accordance with claim 4, wherein the recesses are formed as grooves and/or holes.

6. An assembly in accordance with claim 4, wherein the recesses are produced by a shot blasting process or a sandblasting process.

7. An assembly in accordance with claim 4, wherein the recesses are formed as a laser texturizing.

8. An assembly in accordance with claim 4, wherein the recesses are produced by an etching process.

9. An assembly in accordance with claim 1, wherein the installation surface of the friction ring and/or the contact surface of the synchronizer ring has/have an adhesion-reducing coating.

10. An assembly in accordance with claim 9, wherein the adhesion-reducing coating is formed as a carbon layer, in particular as an amorphous carbon layer.

11. An assembly in accordance with claim 1, wherein the friction ring and the synchronizer ring comprise different materials.

12. An assembly in accordance with claim 11, wherein the friction ring comprises sheet metal and the synchronizer ring comprises brass.

13. A friction ring for an assembly in accordance with claim 1.

14. A synchronizer ring for an assembly in accordance with claim 1.

15. A synchronization unit for a gear-changing transmission having an assembly in accordance with claim 1.

16. A gear-changing transmission for a vehicle having an assembly in accordance with claim 1.
